(19) United States
(12) Patent Application Publication
(10) Pub. No.: US 2006/0194041 A1
(43) Pub. Date: Aug. 31, 2006

(54) Device for releasing an agent to be detected through olfaction

(76) Inventors: Kevin J. Mullally, Neenah, WI (US); Kimberly L. Ellefson, Oshkosh, WI (US); Nefetari B. Murph, Tucker, GA (US); Frank G. Druecke, Oshkosh, WI (US); James A. Cotter, Waupaca, WI (US); Fung-jou Chen, Appleton, WI (US)

Correspondence Address: KIMBERLY-CLARK WORLDWIDE, INC., 401 NORTH LAKE STREET, NEENAH, WI, 54956, US

(21) Appl. No.: 11/069,318

(22) Filed: Feb. 28, 2005

(51) Int. Cl. B32B 27/04; B32B 7/12; B32B 5/02

(52) U.S. Cl. 428/343; 428/352; 428/354; 428/905; 442/96; 442/149

(57) ABSTRACT

The present invention relates to a device, such as a decal, for releasing an agent capable of being sensed through olfaction, generally in conjunction with the use, application, or presence of water or water vapor, as in a shower, spa, bath tub, sink, sauna, basin, or the like. The decal includes a web and an agent that can be released, transmitted, or delivered so that the agent can be sensed or detected through olfaction. The decal further includes an affixation element, such as a bonding material, that attaches the decal to a surface. In some embodiments, the agent may be attached to the web while in other embodiments the agent may form part of the web. In one embodiment, the agent is menthol. In another embodiment, the agent is menthol and is accompanied by a material capable of effervescing. In yet another embodiment, the device for releasing an agent capable of being sensed through olfaction is attached to fixtures or molded surfaces that are typically associated with showers, baths, sinks, etc. (e.g., a shower head, the hot and/or cold levers or handles for activating the flow of water, hardware associated with a shower curtain or door, a spigot, molded handles, and the like). In still another version of the invention, that portion of the device that is associated with the agent may be adjusted along some length of the device. For example, a decal may be adjustably attached to a flexible cord or substantially stiff rod or frame, the cord, rod, or frame capable of being attached to one of the aforementioned fixtures or molded surfaces.

### BACKGROUND

People use various approaches to promote wellness, well-being, and therapeutic approaches to illness, including the use of agents to be sensed or detected by olfaction, such as agents capable of becoming airborne (e.g., volatile compounds).

For example, an individual suffering from a cold may use an ointment incorporating an agent such as menthol or like compounds to alleviate symptoms associated with the blockage of nasal packages.

But agents adapted to be detected by olfaction are used for more than therapeutic purposes. To promote well being, people use various items, e.g., candles, incense, scent devices that are plugged into electric outlets, etc., to deliver agents to help induce various mental or psychological states, including, for example, states of relaxation, peace, sensuality, energy, visualization of specific times and/or places, spirituality, etc. For example, people use candles that systematically release agents relating to lavender, chamomile, mint, etc., to help achieve or recall such mental or psychological states.

For many such cases where a person makes use of an agent for therapeutic purposes, or for well being, the location of the source of the agent relative to the location of the person inhaling, detecting, or sensing the agent can be important. If the source of the agent is too far away from the person seeking to sense or detect the agent, then that person may not effectively obtain the sought-after therapeutic benefits or psychological or mental state that he or she desires.

In addition to the use of agents adapted for the purpose of being sensed or detected through olfaction, people also make use of water, e.g., in the form of a bath or shower, to help promote well being, or to help address the symptoms of a cold or other such illness. For example, a person suffering from a cold may take a hot shower or bath to obtain the benefits of water vapor permeating that person's nasal passages. Alternatively, a person may run hot water in a sink to help release water vapor which that person can then seek to inhale to help alleviate the symptoms of a cold. In some cases, a person may close the door to a bathroom and run hot water in a shower, bath tub, or sink, thereby systematically increasing the amount of water vapor in the bathroom. Or, to help alleviate stress, a person may take a hot shower or bath to help relax that person's muscles.

What is needed is a device adapted to transmit, deliver, or release an agent, or agents, to be sensed or detected through olfaction, and which, when used in conjunction with the application or presence of water or water vapor, can help promote well being, specific psychological or mental states, and/or health.

### SUMMARY OF THE INVENTION

We have discovered that devices that can be conveniently applied or positioned at different locations in a bath tub, shower stall, sauna, spa, sink, basin, or the like can effectively deliver an agent, or agents, to be sensed or detected through olfaction, and which can be used for therapeutic purposes or to help promote well being or desired mental or psychological states.

For example, one version of this invention provides for a convenient and cost-effective decal for delivering an agent to be sensed or detected by a user of the decal through olfaction, e.g., an airborne and/or volatile agent.

In one embodiment of the invention, the decal may be affixed to a surface by an adhesive that is applied to all or part of a surface of the decal. In some versions of the invention, the decal can be applied and reapplied to a surface.

In another embodiment of the invention, at least a portion of a surface of the decal incorporates a mechanical element for affixing the decal to a surface (e.g., a suction cup, a magnetic element for adhering the decal to suitable surfaces, and the like).

Affixation elements other than the adhesive(s) or mechanical element(s) referred to above may be used for affixing the decal to a surface. For example, the decal may comprise a film or other material that adheres to surfaces typically found in bathrooms, showers, spas, sinks, bath tubs, and/or shower stalls (e.g., porcelain, plastic, or metal). Alternatively, a substrate capable of mating with a portion of the decal can be applied separately to a surface (e.g., in a shower stall). For example, a substrate comprising a loop material could be adhered to the surface of, for example, a shower stall, with the decal comprising a hook material capable of both engaging, and, when desired, disengaging from said substrate. Any affixation element that allows the decal to attach to a surface such as that found in a bath tub, shower stall, sink, spa, basin, sauna, or the like can be used.

In one version of the invention, the agent can dissolve, or partially dissolve, in water.

In another version of the invention, the agent is released in a controlled manner, e.g., through micro-encapsulation of the agent such that the agent is released when the micro-capsules are broken mechanically (e.g., by pressing against the decal) or by dissolution or degradation of the micro-capsules or other time-release materials in the presence of water or water vapor. Alternatively, such time-release materials may degrade in air, with the decal kept in a sealed package that is not opened until immediately prior to its use.

In another embodiment of the invention, materials are present in the decal to help facilitate release of the agent (e.g., a compound, or compounds, that effervesce, thereby promoting release of the airborne agent).

The decal can be a layered or non-layered material or web. The agent can be mechanically dispersed or attached throughout the decal; in one or more individual layers or webs, if the decal is made up of multiple layers or webs; at one or both surfaces of the decal; or some combination of these. Furthermore, the agent, whatever its location, can be present uniformly (e.g., uniformly throughout a layer or web; or uniformly over a surface) or non-uniformly. The agent can be bonded or otherwise attached to, or mechanically dispersed in, the decal. Furthermore, the agent can be soluble, or partially soluble, in one or more layers or webs of the decal. So long as the decal is adapted to release the agent so that the agent may be sensed through olfaction, different configurations of the agent and other decal materials may be adopted.

In one embodiment, the decal can be applied and/or re-applied to a surface so that its position is adjustable relative to a person's position-specifically relative to a person's head and nasal passages. For example, to enhance the effects of the agent, a person could position the decal closer to his or her head, whether the person is standing in a shower stall, sitting in a bath tub, lying prone in a bath tub, or holding his or her head over a sink. Furthermore, the decal can be applied and/or re-applied to a surface so that the decal's location relative to water, whether in the form of spray from a shower head, or the water line in a bath or sink, can be adjusted. For those embodiments in which water effects release or dissolution of the agent, the decal could be submerged or partially submerged in water. Or the decal could be positioned so that at least some portion of the spray from a shower head was contacting the decal. Alternatively, the decal could be positioned so that it is exposed to higher concentrations of water vapor.

In another version of the invention, the device for releasing an agent is attached, either directly or indirectly, to fixtures or molded surfaces that are typically associated with showers, bath tubs, sinks, etc. (e.g., a shower head, the hot and/or cold levers or handles for activating the flow of water, hardware associated with a shower curtain or door, a spigot, molded handles, and the like) i.e., the affixation element of the device is designed to be attached to one or more of the above kinds of fixtures.

For example, in one embodiment of the invention, the device for releasing an agent is a flexible, rope-like material that is readily looped around a fixture, molded handle, or the like.

In an alternative embodiment, the device for releasing an agent is a housing or substrate (like the decal detailed above), that is attached to a flexible, rope-like material capable of being attached to a fixture.

In another embodiment, the housing or substrate (e.g., a decal) can be moved, i.e., adjusted, along at least some portion of the length of the flexible, rope-like material.

In another version of the invention, the device for releasing an agent is a housing or substrate (e.g., a decal) attached to a plastic, metal, or other substantially stiff material that can be attached to or looped around a fixture, molded handle, or the like, with the housing or substrate (e.g., a decal) being optionally adjustable along at least some portion of the length of the substantially stiff material.

These and other features, aspects, and advantages of the present invention will become better understood with regard to the following description, appended claims, and accompanying drawings.

### BRIEF DESCRIPTION OF THE DRAWINGS

FIG. 1 is a perspective view illustrating an example decal for delivering, transmitting, or releasing an agent capable of being sensed or detected by olfaction.

FIG. 2 is a section of view of the decal shown in FIG. 1 taken along line 2-2.

FIG. 3 is a section view similar to FIG. 2 illustrating another example decal.

FIG. 4 is a section view similar to FIGS. 2-3 illustrating another example decal.

FIG. 5 is a section view similar to FIGS. 2-4 illustrating another example decal.

FIG. 6 is a section view similar to FIGS. 2-5 illustrating another example decal.

FIG. 7 is a section view illustrating another example decal.

FIG. 8 is a section view similar to FIGS. 7 illustrating another example decal.

### DESCRIPTION OF THE INVENTION

Within the context of this specification, each term or phrase below includes the following meaning or meanings:

“Attach” and its derivatives refer to the joining, adhering, connecting, bonding, sewing together, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Affix” and its derivatives refer to the joining, adhering, connecting, bonding, sewing together, or the like, of two elements. Two elements will be considered to be affixed together when they are integral with one another or affixed directly to one another or indirectly to one another, such as when each is directly affixed to intermediate elements. “Affix” and its derivatives include permanent, releasable, or refastenable affixation. In addition, the affixation can be completed either during the manufacturing process or by the end user.

“Bond” and its derivatives refer to the joining, adhering, connecting, attaching, sewing together, or the like, of two elements. Two elements will be considered to be bonded together when they are bonded directly to one another or indirectly to one another, such as when each is directly bonded to intermediate elements. “Bond” and its derivatives include permanent, releasable, or refastenable bonding.

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

The terms “disposed on,” “disposed along,” or “disposed toward” and variations thereof are intended to mean that one element can be integral with another element, or that one element can be a separate structure bonded to or placed with or placed near another element.

“Layer” when used in the singular can have the dual meaning of a single element or a plurality of elements.

“Nonwoven” and “nonwoven web” refer to materials and webs of material that are formed without the aid of a textile weaving or knitting process. For example, nonwoven materials, fabrics or webs have been formed from many processes such as, for example, meltblowing processes, spunbonding processes, air laying processes, and bonded carded web processes.

“Olfaction,” “olfactory,” and like terms refer or relate to the process by which agents, materials, or compounds are sensed or detected by a person through his or her sense of smell. Thus agents relating to smells, odors, aromas, aromatherapy, and the like may be sensed through “olfaction.” Because the present invention may be used by persons whose olfactory senses are impaired (e.g., through blocked nasal passages resulting from a cold, flu, allergy, or the like)-and in fact the present invention may help alleviate such symptoms (e.g., through use of menthol or like compounds as an agent)—“olfaction,” “olfactory,” and like terms also refer or relate to an impaired process for sensing or detecting agents, materials, or compounds.

“Release,” “transmit,” or “deliver” refer or relate to an agent that is initially associated with a device (e.g., a decal), but which is made available (e.g., through volatilization) to be sensed or detected by a person through olfaction (e.g., the volatilized agent becomes airborne and is then available to be inhaled).

“Web” refers to any type of substrate including laminates of one or more types of material. A web may include any type of layer or material, such as films of thermoplastic material, a nonwoven web of thermoplastic material or a combination of thermoplastic material and natural fibers such as wood pulp fluff fibers, woven webs made of strands of thermoplastic material, natural material such as threads of cotton and the like, polymers, waxes or combinations thereof, other such flexible polymer matrices, and the like. A web may also be formed of multiple layers of materials.

The terms “shower,” “bath,” “spa,” and “water basin” refer to a device, room, compartment, or environment where water or water vapor is transmitted or applied, typically to a user of said shower, bath, spa, or water basin.

These terms may be defined with additional language in the remaining portions of the specification.

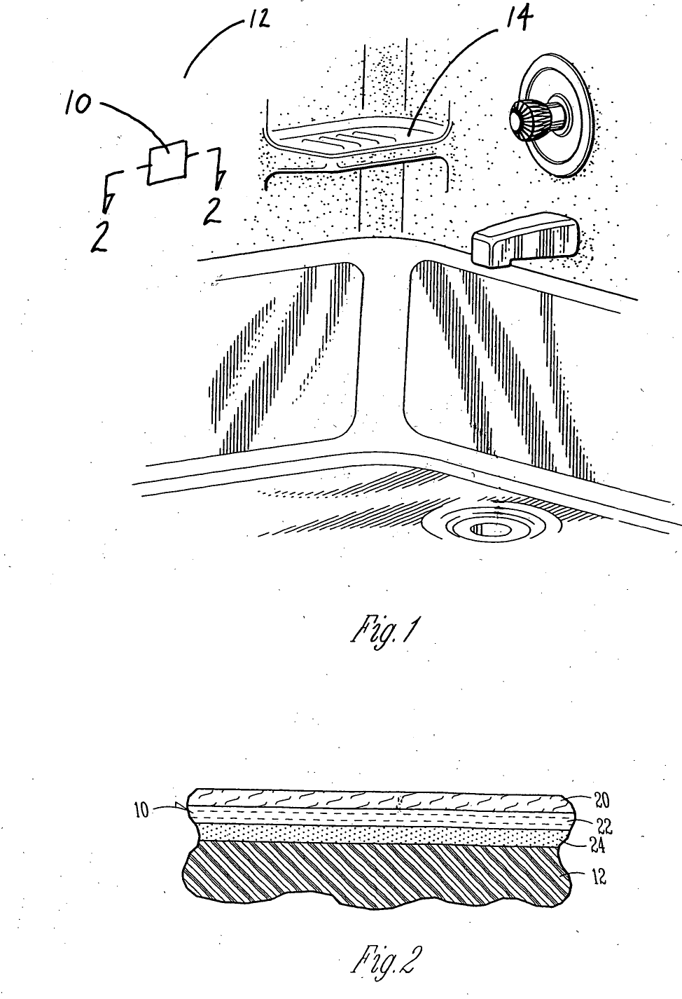

FIG. 1 illustrates a decal 10 for delivering an agent capable of being sensed or detected by the user of the decal through olfaction. The decal 10 is affixed to a surface 12. Although the decal 10 is shown in FIG. 1 as affixed to a surface 12 near a molded soap dish 14, it should be noted that the decal 10 may be affixed to any surface proximate to a user when the user is taking a bath, taking a shower, using a sink, and the like. In addition, the decal 10 may be placed on any vertical or horizontal surface. A user may affix the decal in a position proximate to the user's location, especially the location of the user's head and nose, to increase the ability of the user to sense or detect, through olfaction, an agent delivered, transmitted, or released from the decal. For example, if the user is standing in a shower, then the user can affix the decal to the inner surface of the shower compartment such that the decal is located at about the same distance above the shower compartment's floor as the user's head. If, on the other hand, the user is lying prone in a bath tub, the user can affix the decal at a location in the tub proximate to the user's head. Alternatively, if the user, for therapeutic purposes, is running hot water in a sink, shower, or tub to generate water vapor, then the user of the decal could affix the decal at a location proximate to the user's head and nose. Also, as discussed above, a user can position the decal 10 so that the decal is impacted, directly or indirectly, by water or water vapor. As discussed below, decal 10 may also be attached to a length of material (e.g., a flexible rope-like material; or a substantially stiff rod), with the length of material then being attached to, for example, a fixture. In some cases, the position of decal 10 is adjustable along at least some portion of the length of material.

As shown in FIGS. 2-4, the various examples of a decal 10 include a web 20 and an agent 22, said agent being capable of being sensed by a user of the decal through olfaction. The decal 10 further includes an affixation element, in this case bonding material 24, which is attached to the web 20. The bonding material 24 is used to attach the decal 10 to the surface 12. The bonding material may be applied uniformly or non-uniformly to the decal. Furthermore, as discussed below, the bonding material may be of a type that permits the removal and re-affixation, perhaps at a different location, of the decal 10.

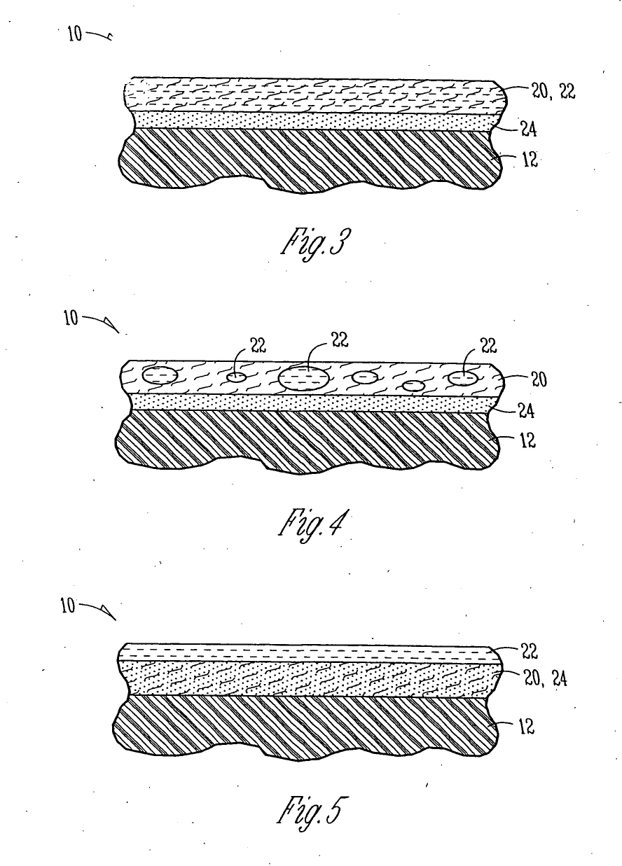

The agent 22 is attached to (FIG. 2), or made part of (FIGS. 3 and 4), the web 20 through any method known now or discovered in the future. The agent 22 capable of being sensed by the user of the decal through olfaction can be dispersed or attached uniformly throughout the decal or one or more layers in the decal; in a gradient or other pattern throughout the decal or one or more layers in the decal; or sandwiched between or at the interface of one or more layers in the decal, as in a pocket between two layers. Again, so long as the decal is capable of releasing the agent so that the agent is capable of being sensed through olfaction, different configurations of the agent and other decal materials may be adopted.

The openness or air permeability of the web or webs making up device 10 may be selected to control or limit the diffusion of certain highly volatile and/or strong agents 22. Suitable cover materials include, but are not limited to, nonwoven webs, knitted and/or woven fabrics, porous foams and films, reticulated foams and films, and so forth. Exemplary nonwoven webs include, but are not limited to, spunbond fabrics, bonded carded webs, and laminates thereof. Methods of making the aforesaid cover materials are well known in the art. However, by way of example only, exemplary materials are described in U.S. Pat. No. 3,727,615 to Duchane; U.S. Pat. No. 3,802,817 to Matsuki et al.; U.S. Pat. No. 3,849,241 to Butin et al.; U.S. Pat. No. 4,041,203 to Brock et al.; U.S. Pat. No. 4,100,324 to Anderson et al.; U.S. Pat. No. 4,720,415 to VanderWielen; U.S. Pat. No. 4,781,962 to Zamarripa et al.; U.S. Pat. No. 4,965,122 to Morman; U.S. Pat. No. 5,284,703 to Everhart et al.; U.S. Pat. No. 5,382,400 to Pike et al.; U.S. Pat. No. 5,385,775 to Wright; U.S. Pat. No. 5,707,707 to Burnes et al.; U.S. Pat. No. 5,714,107 to Levy et al.; U.S. Pat. No. 5,858,515 to Stokes et al.; U.S. Pat. No. 6,315,864 to Anderson et al. and so forth.

In the example embodiment illustrated in FIG. 2, the web 20 and agent 22 are formed as separate layers that are joined together. FIGS. 3 and 4 show that the agent 22 may also be incorporated into web 20. FIG. 3 shows that the agent 22 may be at least partially, or wholly, soluble in the web 20, while FIG. 4 shows that the agent may be suspended in the web 20. A range of materials can be used to hold the agent 22 and/or form the web 20 such that the agent 22 is released over time. These materials may include one or more thermoplastics, organic polymers (e.g., natural polysaccharides), starches, gums, alginate and xanthan (among other materials). Such materials may degrade after exposure to water, water vapor, or air.

The agent can be microencapsulated so that the agent is released only, for example, after the microcapsules dissolve upon exposure to water or water vapor; or break due to an applied force (e.g., the user presses down on the decal, thereby compacting the microcapsules and releasing the agent); or the like. Alternatively, the microcapsules may degrade upon exposure to air. Many encapsulation techniques known in the art can be utilized including those which provide sustained release, triggered release, targeted release or a combination of these release mechanisms. Other release mechanisms known in the art and suitable for use in accordance with the present invention include friction/pressure release, pH related release, water release, water evaporation release, and the like. The agent 22 can be encapsulated in starch, dextran, or other degradable or soluble materials, such that microcapsules can permit gradual release of the agent upon wetting, an increase in temperature, or physical contact. The microencapsulated agents should be constructed such that humidity from atmospheric conditions during storage or shipment of the device will resist breakdown of the microcapsules that would result in a premature release of the agent 22. Alternatively, the decals can be packaged in a material that is resistant to penetration by water and water vapor, thereby protecting the microcapsules from degradation until the package containing the decal, or decals, is opened. Materials suitable for use in combination with agents described herein include those available from Salvona, LLC (Dayton, N.J.).

In the example embodiment illustrated in FIG. 2, web 20, agent 22 and bonding material 24 are formed as separate layers. Although web 20, agent 22 and bonding material 24 are shown as layers of the same size, it should be noted that the layers may be different sizes and/or shapes.

In other embodiments, agent 22 may be stored in a reservoir layer when the agent 22 is part a laminate structure. The laminate structure may include a rate limiting layer that releases the agent 22 over time.

The agent 22 may also be placed in a porous material (e.g., foam, a porous net-like substrate, or the like) that releases agent 22 over time. The release rate of the agent 22 will be determined in part by the nature of the porous material and the form of the agent 22 (i.e., liquid, powder or solid).

In alternative embodiments, the agent 22 may be incorporated into a substance that dissolves away over time as the decal 10 is exposed to moisture (e.g., water or water vapor). Therefore, as the substance dissolves, agent 22, or a portion thereof, is released.

Agent 22 may be any material capable of being transmitted through the air so that a user of the decal can sense agent 22 through olfaction. The agent 22 may be of a beneficial, therapeutic use, such as menthol or related compounds. Agent 22 may also be of a type that helps facilitate a pleasing psychological state. For example, agent 22 can comprise any of a variety of materials including viscous and non-viscous liquids such as solutions, emulsions, dispersions, gels and so forth. Further, the agent can also include solids having a distinct smell and that readily volatilize upon exposure to air such as, for example, certain organic solids. In one aspect of present invention, the agent can comprise one or more fragrant materials or materials that provide chemically active vapors. In one embodiment, the agent can comprise and/or include volatile, fragrant compounds including, but not limited to, perfumes, essences, fragrance oils, and so forth. As is known in the art, many essential oils and other natural plant derivatives contain large percentages of highly volatile scents. In this regard, numerous essential oils, essences, and scented concentrates are commonly available from companies in the fragrance and food businesses. Exemplary oils and extracts include, but are not limited to, those derived from the following plants: almond, amyris, anise, armoise, bergamot, cabreuva, calendula, canaga, cedar, chamomile, coconut, eucalyptus, fennel, jasmine, juniper, lavender, lemon, orange, palm, peppermint, quassia, rosemary, thyme, and so forth.

Many fragrances have colors associated with the fragrance. For example, the color lavender or purple is often associated with a lavender scent; the color yellow is often associated with a chamomile scent, a daffodil and the like; the color red is often associated with a rose scent and the like; and the color green is often associated with the scents of aloe, wintergreen and the like; Accordingly, the color of a device of the present invention, i.e. decal 10, may be selected to create a mental association between the user of the device and the agent that is capable of being sensed by the user through olfaction. Other color and scent combinations may be utilized in the present invention.

As stated above, the sensing of an agent 22 through olfaction can be used to help induce a desired psychological state, including a state in which the user is contemplating one or more mental states, including, for example, states of relaxation, peace, sensuality, energy, visualization of specific times and/or places, spirituality, visualization of various natural settings, etc.

As discussed above, other the decal 10 may comprise other ingredients in addition to agent 22. For example, decal 10 may also comprise an ingredient, or ingredients, that effervesce. Many effervescent materials combine carbonate salts (e.g., sodium carbonate and/or sodium bicarbonate) with an acidic material such as citric, malic, or fumaric acid to generate carbon dioxide gas. Carbon dioxide is gas that is generated by a neutralization reaction that occurs when the acid and carbonate come into contact with one another. The neutralization reaction may be accelerated by dissolving the materials in close proximity to each other.

In addition, when decal 10 comprises an effervescent material, the porosity of the first web may regulate the rate of effervescence. The rate of effervescence may be regulated by controlling (i) the escape of gas from the decal 10; and/or (ii) the degree of contact between the water and/or water vapor and the effervescent material.

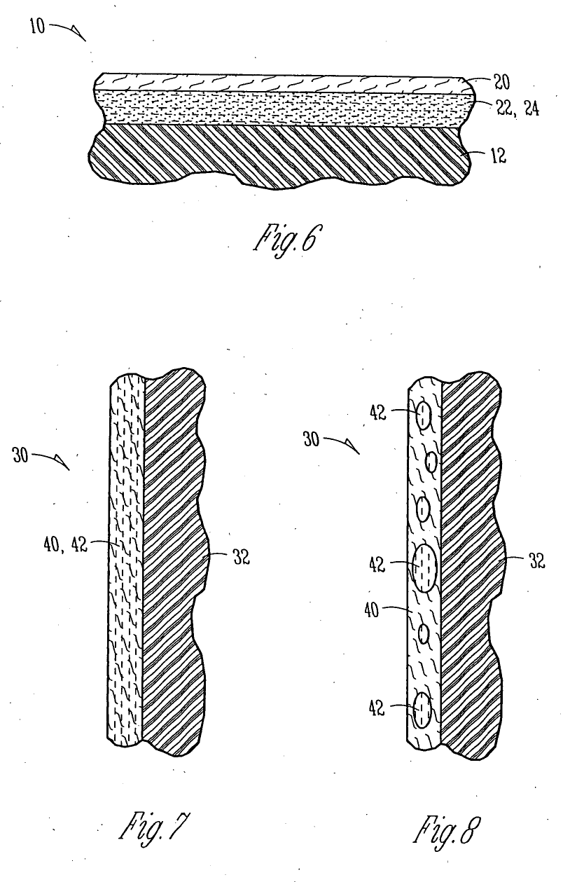

As discussed above, the decal 10 further includes a bonding material 24 that attaches the decal 10 to the surface 12. The bonding material 24 may be attached to the web 20 and/or agent 22 (FIG. 2), or made part of the web 20 (FIG. 5) or agent 22 (FIG. 6), through any method known now or discovered in the future. In the example embodiment illustrated in FIG. 2, the bonding material 24 is in the form of an adhesive layer that is attached to the web 20 and agent 22. The backside of the decal 10 is readily attached to the surface 12 by adhering the adhesive layer to the surface 12.

In some embodiments, the adhesive layer attaches the decal 10 to the surface 12 until the decal 10 is peeled off so that no adhesive or residue is left behind on the surface 12. The quantity and type of bonding material 24 in the decal 10 will be based on the properties that are desired within particular commercial products.

In the example embodiment illustrated in FIG. 2, the web 20, agent 22 and bonding material 24 are formed as separate layers that are joined together. Although the web 20, agent 22 and bonding material 24 are shown as layers of the same size, it should be noted that the layers may be different sizes and or shapes.

As discussed above, the agent bonding material 24 may be separate from the web 20 and agent 22 (FIG. 2), or form part of the web 20 (FIG. 5) or agent 22 (FIG. 6). In embodiments where the bonding material forms part of the web 20 and/or agent 22, the bonding material 24 may be (i) suspended in the web 20 and/or agent 22; or (ii) soluble in the web 20 and/or agent 22.

In embodiments where the bonding material 24 is separate from the web 20 and the agent 22, the bonding material 24 may dissolve away over time as the decal 10 is exposed to moisture (e.g., water). In other embodiments where the bonding material 24 forms part of the web 20 or agent 22, the bonding material 24 may dissolve away over time along with the web 20 and/or agent 22.

Some example materials that may be used for the bonding material 24 include pressure-sensitive adhesives (PSAs), hotmelt adhesives, reactive adhesives (e.g., isocyanates, cyanoacrylates, acrylics, ethylvinylacetates), latex adhesives and epoxies. The type of bonding material 24 will be selected based on processing parameters, solubility and whether the bonding material forms part of the web 20 and/or agent 22 (among other factors).

Other example adhesives that may be used for the bonding material 24 include EVA (ethylene vinyl acetate) hotmelts (e.g., copolymers of EVA), polyolefin hotmelts, polyamide hotmelts, pressure sensitive hot melts, styrene-isoprene-styrene (SIS) copolymers, styrene-butadiene-styrene (SBS) copolymers; ethylene ethyl acrylate copolymers (EEA); polyurethane reactive (PUR) hotmelts, and poly(alkyloxazoline) hotmelt compounds (among others). Some specific examples of adhesives that may be suitable for some embodiments include (i) SUNOCO CP-1500 (an isotactic polypropylene) of Sunoco Chemicals (Philadelphia, Pa.); (ii) Eastman C10, Eastman C18, and Eastman P1010 (an amorphous polypropylene) of Eastman Chemical (Longview, Tex.); (iii) HM-0727, HM-2835Y, and 8151-XZP of H.B. Fuller Company (St. Paul, Minn.); and (iv) National Starch 34-1214 made by National Starch and Chemical Corp. (Bridgewater, N.J.).

The decal 10 may be attached to surface 12 using other approaches, so long as the decal remains suitably affixed or connected to the surface. The fastening system 60 may include any refastenable fasteners suitable for absorbent articles, such as adhesive fasteners, cohesive fasteners, mechanical fasteners, or the like. In one aspect of the invention, the fastening system includes mechanical fastening elements for improved performance. Suitable mechanical fastening elements can be provided by interlocking geometric-shaped materials, such as hooks, loops, bulbs, mushrooms, arrowheads, balls on stems, male and female mating components, buckles, snaps, or the like. For example, fastening systems are also disclosed in the previously incorporated PCT Patent Application WO 00/37009 published Jun. 29, 2000 by A. Fletcher et al. and the previously incorporated U.S. Pat. No. 6,645,190 issued Nov. 11, 2003 to Olson et al.

Other affixation elements include, for example, a suction cup, a magnet, a film, or other mechanical element (e.g., a U-shaped rod that is capable of being fit over, for example, a shower head; or a flexible rope that is capable of being looped around, for example, a shower head) that readily attaches and/or adheres to the kinds of materials typically used to construct a bath tub, shower stall, sauna, spa, sink, basin, or the like, as well as accompanying fixtures (e.g., a shower head, the hot and/or cold levers or handles for activating the flow of water, hardware associated with a shower curtain or door, a spigot, molded handles, etc.).

For certain affixation elements comprising a length of material, such as a U-shaped rod; a flexible rope, or other like modes of attachment, the decal 10 may be adjustable along at least some portion of the length of material.

The decal 10 may also include pH adjusting agents that are released at a slow rate to raise or lower the pH of water that engages the decal 10 or surface 12. The pH of the water may be manipulated to change release or performance of the agent 22.

FIGS. 7 and 8 illustrate another example decal 30 attached to a surface 32. The decal 30 includes a web 40 and an agent 42 for affixing to a surface. The agent 42 is incorporated into the web 40. The web 40 is tacky enough such that the web 40 is able to adhere the decal 30 to the surface 32. FIG. 7 shows that the agent 42 may be at least partially, or wholly, soluble in the web 40, while FIG. 8 shows that the agent 42 may be suspended in the web 40.

The agent 42 may be made part of the web 40 through any method known now or discovered in the future. The web 40 may include any type of layer or material, such as films of thermoplastic material, as long as the web 40 is able to adhere the decal 30 to a surface 32. The web 40 may also be formed of multiple layers of materials.

As discussed above, a range of materials can be used to hold the agent 42 and/or form the web 40 such that the agent 42 is released over time. In addition, the agent 42 may be similar to any of the agents 22 described above. The type and quantity of agent 42 in the decal 30 will be based on the properties that are desired within particular commercial products.

As part of fabricating decal 10, multiple decals may be cut from a sheet that is feed out from a continuous roll. The multiple decals may then be stacked for packaging or delivered as the continuous roll. In some forms, multiple decals may be inter-folded, o-folded and/or compressed into various geometric shapes. In addition, when the decals are stacked, the decals may be separated by a substrate that serves as a barrier between the decals. In addition, the decal 10 may be embossed with logos, use instructions or any other design or information.

It should be noted that one or more of the web 20, agent 22 and bonding material 24 may be partially, or wholly, soluble in a liquid (e.g., water) such that one or more of the web 20, agent 22 and bonding material 24 are readily dissolved when the decal 10 is exposed to water. The type of web 20, agent 22 and bonding material 24 will be selected based on (i) processing parameters; (ii) dispensing characteristics; (iii) packaging issues; and (iv) solubility.

In addition, the web 20, agent 22 and bonding material 24 should have the properties that are required for a particular product and/or process. The web 20, agent 22 and bonding material 24 properties may be controlled to define properties such as melting temperature, shear strength, viscosity, crystallinity, solid phase matrix, hardness, tackiness and heat stability (among other properties).

It should be noted that one or more decals 10 may applied to target areas on a surface in a geometric or random pattern. As an example, the decal 10 may be in the form of a continuous strip. The decal 10 may also be decorative in color and/or shape depending on consumer appeal.

There are also embodiments that are contemplated where the decal 10 has a clear and/or unobtrusive product form such that the decal 10 discreet and does not interfere with the aesthetics of the room where the surface 12 is located. In addition, the decal 10 may include an indicator (e.g., a section that changes color) that provides information as to when the decal 10 is out of agent 22 and requires replacement.

### EXAMPLE

A round, six-inch diameter, piece of a commercially available Huggies® Baby Changing pad was cut from the pad. (the pad is available from Kimberly-Clark Corporation, having offices in Neenah, Wis.) This pad comprised two layers (as in a laminate): a double-recrepe tissue web; and a film layer. The six-inch diameter piece was placed with the film side down onto a work surface. The tissue side was facing up. One half of a commercially available effervescent tablet from Phyzz Inc. (sold under the name “Sinus Soothing Mist Shower Tablets”) was ground into approximately pea-size granules and placed on top of the circular piece of baby-changing pad. A six-inch diameter round piece of commercially available Wypall X-60 hydroknit material was placed on top of the changing pad and effervescent granules (Wypall X-60 is available from Kimberly-Clark Corporation). The circular materials were joined together at their outer perimeters, one resting on the other, by sewing with the materials with thread to form a sealed pouch. As the outer perimeter of the circular materials were joined together by sewing, a each end of a piece of cord was sewn in to make a loop, the loop allowing for the decal to be hung from a shower head or plumbing fixture. It is anticipated that the device, when used, will provide one or more of the possible benefits described herein, such as helping to provide relief from cold or other symptoms.

While the invention has been described in detail with respect to specific embodiments, it will be appreciated that there are variations of, and equivalents to these embodiments. Accordingly, the scope of the present invention should be determined by the appended claims and any equivalents thereto.

What is claimed is:

1. A shower, bath, spa, or water-basin decal adapted to release an agent to be sensed by olfaction, the decal comprising:
a web;
an agent attached to, and adapted to be released from, the web; and
an affixation element for affixing the decal to the shower, bath, spa, or water-basin, wherein the affixation element is attached to the web.

2. The decal of claim 1 wherein the agent is adapted to be released upon exposure of the decal to water, water vapor, or an applied force.

3. The decal of claim 2 wherein the web is a flexible substrate.

4. The decal of claim 3 wherein the affixation element is an adhesive adapted to be affixed to a surface of the shower, bath, spa, or water-basin.

5. The decal of claim 4 wherein the adhesive is adapted to releaseably affix to the surface.

6. The decal of claim 1 wherein the affixation element is adapted to attach to a fixture attached to a shower, bath, spa, or water-basin.

7. The decal of claim 6 wherein the web is adapted to be adjusted along at least a portion of the affixation element.

8. The decal of claim 2 wherein the agent is suspended in the web.

9. The decal of claim 2 comprising at least one additional ingredient.

10. The decal of claim 9 wherein the additional ingredient is adapted to effervesce when exposed to water or water vapor.

11. A shower, bath, spa, or water-basin decal adapted to release an agent to be sensed by olfaction, the decal comprising:
a web comprising at least two layers;
an agent attached to, and adapted to be released from, the web; and
an affixation element for affixing the decal to the shower, bath, spa, or water-basin, wherein the affixation element is attached to the web.

12. The decal of claim 11 wherein at least a portion of the agent is disposed between two layers.

13. The decal of claim 12 wherein the agent is adapted to be released upon exposure of the decal to water, water vapor, or an applied force.

14. The decal of claim 13 comprising at least one additional ingredient.

15. The decal of claim 14 wherein the additional ingredient effervesces when exposed to water or water vapor.

16. The decal of claim 11 wherein the affixation element releaseably affixes to the shower, bath, spa, or water basin.

17. A shower, bath, spa, or water-basin decal adapted to release an agent to be sensed by olfaction, the decal comprising:
a web; and
an agent attached to, and adapted to be released from, the web.

18. The decal of claim 17 wherein the web comprises a material capable of adhering to a surface of the shower, bath, spa, or water-basin.

19. The decal of claim 17 further comprising an affixation element for affixing the decal to the shower, bath, spa, or water-basin, wherein the affixation element is attached to the web, and wherein the affixation element is adapted to be attached to a fixture attached to a shower, bath, spa, or water-basin.

20. The decal of claim 19 wherein the web is adapted to be adjusted along at least a portion of the affixation element.
